(19) United States
(12) Patent Application Publication
(10) Pub. No.: US 2008/0159402 A1
(43) Pub. Date: Jul. 3, 2008

(54) Motion vector prediction method and prediction apparatus thereof

(75) Inventors: Hsin-Hao Chen, Hsinchu (TW); Chih-Yu Chang, Hsinchu (TW); Oscal T.-C. Chen, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 12/000,985

(22) Filed: Dec. 19, 2007

(30) Foreign Application Priority Data
Dec. 29, 2006 (TW) 095150065

(51) Int. Cl. H04N 7/12

(52) U.S. Cl. 375/240.16; 375/E07.243

(57) ABSTRACT

A motion vector (MV) prediction method and a prediction apparatus thereof are applicable for a video image encoder/decoder to predict an MV of a video image. Firstly, segment a macroblock in the video image into microblocks. Then, configure a row memory and three register memories to register the MV required for prediction. Finally, the MV stored in the row memory or the register memories at a position corresponding to the current microblock to be predicted is used to predict the MV of the current microblock to be predicted in the current macroblock to be predicted. After the prediction is completed and moved to another macroblock or microblock, the MV stored in the row memory or the register memories is updated according to a predetermined storage updating condition.

### CROSS-REFERENCE TO RELATED APPLICATIONS

This non-provisional application claims priority under 35 U.S.C. §119(a) on Patent Application No(s). 095150065 filed in Taiwan, R.O.C. on Dec. 29, 2006, the entire contents of which are hereby incorporated by reference.

### BACKGROUND OF THE INVENTION

1. Field of Invention

The present invention relates to a motion vector (MV) prediction method and a prediction apparatus thereof, and more particularly to a motion vector prediction method and a prediction apparatus thereof, capable of saving a memory space required to register other MVs for assisting the prediction when predicting an MV.

2. Related Art

With the rapid progress of the broadband transmission environment, high-quality video image transmission will become an inevitable trend of the future. Moreover, as hardware equipment has become more popular and cheaper, the demand for high-quality video image service is also increased. However, as the data volume for the high-quality video image is quite large, during the transmission of the video image, regardless of the network streaming transmission, communication transmission, or multimedia playing transmission, the video image must be encoded properly (i.e., the compression), so as to transmit the video image effectively and smoothly with a limited bandwidth or under the restriction of the capacity.

The typical encoding is realized with a video image encoder, which mainly uses the characteristic of a high time domain correspondence between video images, and employs the motion vector (MV) prediction technology to directly place an MV into a macroblock to be encoded, for representing a distance between the macroblock and a most similar reference block in a reference image. Thus, the encoded (resulted) data volume can be significantly reduced. In fact, not only between video images, but the neighboring macroblocks in the same video image also have a motion mode correspondence to a certain extent, which provides a space for further reducing the encoded data volume.

Currently, common encoding technical standards include MPEG-1 for VCD and MPEG-2 for DVD. Moreover, later developed MPEG-4 has become the dominant encoding technical standard in recent years due to its high performance and the distinguished very-low-bit-rate coding capability. Recently, an encoding technical standard, MPEG4-Part 10, appears in the field, which has been considered the encoder with the best performance among all encoding technologies. Besides international video compression standards, some companies or states also develop several non-universal video compression standards, e.g., Windows Media Video (WMV) encoding technology developed by Microsoft and AVS encoding technology officially developed by Mainland China.

These encoding technologies actually adopt similar architectures, and the tiny difference in implementing method only lies in the means for some parts, as different factors are taken into consideration. Basically, the encoding technologies are all based on the time domain correspondence between video images and space correspondence in a video image. The purposes of these encoding technologies are totally the same, i.e., to reduce the data volume to be processed during the encoding through ME (Motion Estimation) and MV prediction technology. During the decoding process, the original MVs can be restored as long as the same MV prediction technology used in the encoding process is carried out in the decoder side. Taking the VC-1 encoding technology developed by Microsoft as an example, the video image encoder architecture provided according to VC-1 is characterized in incorporating the common interlaced scanning technology in the encoding technology, and other aspects of this architecture are similar to other technologies. Furthermore, the video image decoder architecture provided according to WMV is also the same as other encoding technologies. FIG. 1 shows a VC-1 decoder developed by Microsoft. As shown in FIG. 1, an inputted video image is basically processed along two paths. The residue path deals with data of intra-coded blocks and residues of inter-coded blocks, including processing zones such as a variable length decoder 10, an inverse quantization module 11, and an inverse transformation module 12. The frames decoded along this path will pass through an internal filter 13, and be stored in a frame buffer 14 for being used by the other path. The motion-compensation path mainly includes a motion vector prediction block 20 and a motion compensation zone 23. The motion vector prediction block 20 mainly includes another variable length decoder 21 and a motion vector prediction module 22, and the motion compensation zone 23 includes a motion compensation module 24 and the intensity compensation module 25. The operation details of the decoder can be known with reference to the technical description provided in early U.S. Patent Publication 20050013498, which thus are not repeated herein.

Generally speaking, the video image encoder segments a video image into an integer number of macroblocks (normally, the length and width of the macroblocks are both 16 pixels, so the size of the macroblocks is 16×16 pixels) before the encoding. However, some encoding technologies will further segment the macroblocks into microblocks, in order to improve the encoding efficiency. The sizes of the segmented microblocks can be determined freely, for example, 16×8 pixels, 8×16 pixels, 8×8 pixels, or 4×4 pixels. Different MV prediction methods are used to process the MV prediction of each of the macroblocks according to the number of microblocks segmented from a macroblock. For example, in case that a macroblock is represented by an MV only, the macroblock can be referred to as a 1 MV-MB; when all macroblocks in the video image are 1 MV-MBs, the video image can be referred as a 1 MV video image, and as shown in FIG. 2A, the entire video image is formed by 1 MV macroblocks 30. Or, various microblocks of a macroblock can be represented by individual MVs. Assumed that one macroblock is segmented into four microblocks, one macroblock can be represented by four MVs, and this type of macroblock is referred to as a 4 MV-MB; Certainly, it is also possible that a video image having 1 MV macroblocks 30 and 4 MV macroblocks 30 formed by four microblocks 301 at the same time, and the video image is referred as a Mixed-MV video image, as shown in FIG. 2B.

No matter what kind of encoding/decoding technologies (or encoders/decoders) are applied, the aforementioned MV prediction is essentially required for processing a large quantity of video images. During this process, any MV prediction must be allocated with a memory to properly store other MVs required in the prediction, such that they can be used in the MV prediction. Generally speaking, without a proper MV prediction method and a memory allocation and management mechanism, the MV prediction will be ineffective, and a large memory space will be wasted. Most current technical content, such as U.S. Patent 20050013498, does not provide any clear and detailed solution to the problem of how to perform the memory allocation and management in cooperating with the MV prediction method.

### SUMMARY OF THE INVENTION

In view of the above problems, the present invention provides a motion vector (MV) prediction method and a prediction apparatus thereof. Through the MV prediction method, memory allocation, and memory updating management mechanism disclosed in the present invention, the memory space required during the MV prediction is saved, and the overall efficiency to implement the MV prediction is improved.

To achieve the aforementioned object, the motion vector prediction method and the prediction apparatus disclosed in the present invention are realized through the following manners:

(1) a memory allocation means, for allocating a row memory, a first register memory, a second register memory, and a third register memory in a video image encoder/decoder.

(2) a video image segmentation means, for segmenting each macroblock in a video image, such that each of the macroblocks includes a first microblock, a second microblock, a third microblock, and a fourth microblock of the same size.

(3) an MV prediction means, for reading an MV of each predicted microblock in a neighboring microblock row above a macroblock row that is currently to be predicted, storing the MVs to the row memory, and sequentially performing an prediction for the first microblock, the second microblock, the third microblock, and the fourth microblock of the macroblock that is currently to be predicted.

The MV prediction means mainly uses the first register memory, the second register memory, and the third register memory to store microblock MVs meeting a predetermined position condition corresponding to the microblock that is currently to be predicted, so as to perform the MV prediction of the first microblock, the second microblock, the third microblock, and the fourth microblock; and when the microblock that is currently to be predicted or the macroblock that is to currently to be predicted changes, the MV prediction means updates data stored in the row memory, the first register memory, the second register memory, or the third register memory according to a predetermined storage updating condition.

The present invention is an MV prediction mode based on 4 MV macroblocks, so it is universal and can be applied in other types of video images. Moreover, the present invention can save the required memory space, and utilize the memory most effectively.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic view of the architecture of a conventional encoder;

FIGS. 2A and 2B are schematic views of video images of the conventional 1 MV, 4 MV, and mixed-MV respectively;

FIG. 3 is a schematic view of the memory allocation and the row memory storage of a motion vector prediction apparatus according to the present invention;

FIG. 4 is a schematic view of positions of microblocks in the macroblock according to the present invention;

FIGS. 5A to 5G are schematic views of motion vectors stored in each register memory when the motion vector prediction method of the present invention is used to perform the motion vector prediction to each microblock in the current macroblock to be predicted;

FIG. 6 is a schematic flow chart for updating the row memory and the register memories in the motion vector prediction method of the present invention when the microblock that is currently to be predicted or the macroblock that is currently to be predicted changes; and

FIG. 7 is a schematic view of updating the row memory according to the motion vector prediction method of the present invention.

### DETAILED DESCRIPTION OF THE INVENTION

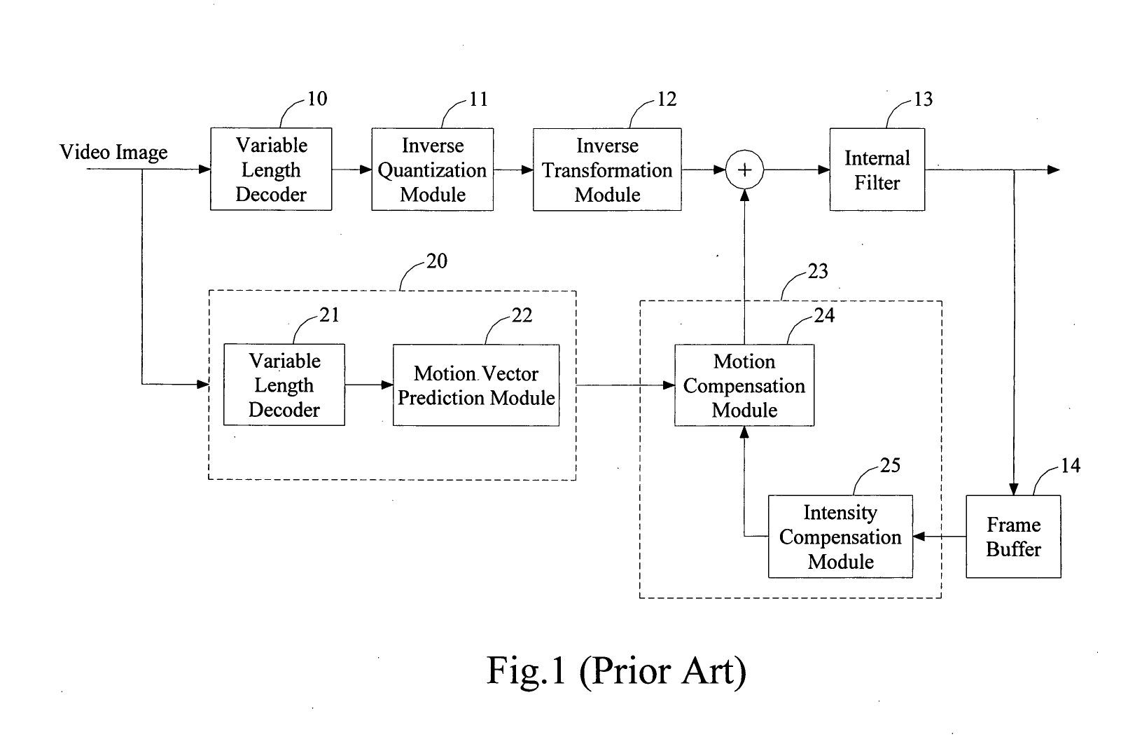

The present invention provides a motion vector (MV) prediction method and a prediction apparatus thereof, which are applicable for a video image encoder/decoder to perform an MV prediction to video images. Taking the implementation aspect of the encoder of FIG. 1 as an example, the realization of the present invention will be applied in the motion vector prediction module 22 (referred to as MV prediction apparatus hereinafter) in the motion vector prediction block 20.

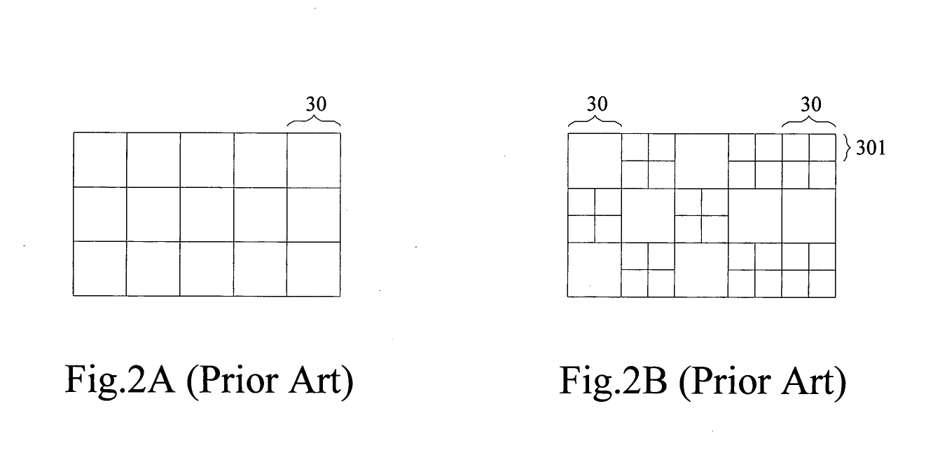

As the MV prediction method and the MV prediction apparatus 22 provided by the present invention is supported by a memory allocation management mechanism disclosed in the present invention, the limited memory space can be used to realize effective MV prediction, so as to substantially reduce the use of the memory space. In particular, the MV prediction apparatus 22 realized as a hardware can save the cost, and enhance the processing efficiency of the MV prediction. Moreover, as the MV prediction method based on 4MV-MB video images is utilized, the MV prediction method and the MV prediction apparatus 22 of the present invention are applicable for various video images, including the 1 MV video image of FIG. 2A, and the Mixed-Mv video image of FIG. 2B. The MV prediction of the aforementioned video images can all be preformed through the present invention.

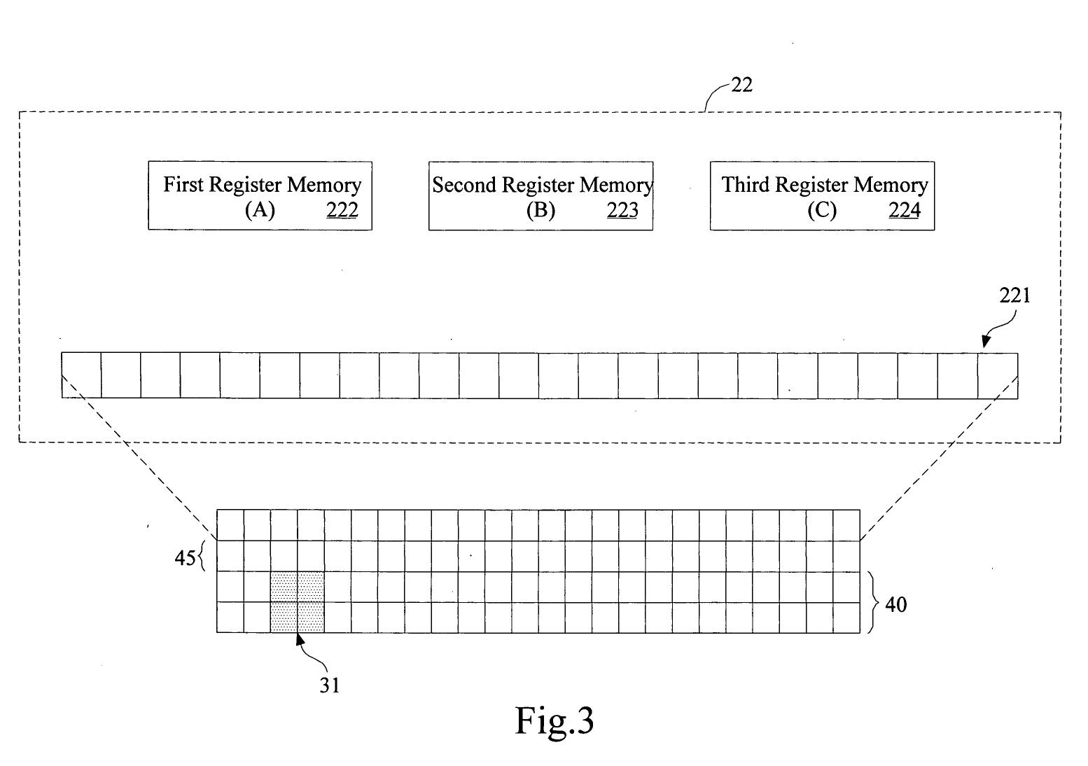

FIG. 3 is a schematic view of the memory allocation and row memory storage for the MV prediction apparatus 22 of the present invention. As shown in FIG. 3, in the MV prediction method of the present invention, a row memory 221 and three register memories must be allocated in the MV prediction apparatus 22 through a memory allocation means. The three register memories are a first register memory 222 (shown as A in a part of the figure), a second register memory 223 (shown as B in a part of the figure), and a third register memory 224 (shown as C in a part of the figure). The row memory 221 is used to store the MV of each microblock in a neighboring macroblock row 40 above the macroblock row 40 that is currently to be predicted, and the length shall be the same as the number of microblocks in a horizontal direction of a video image; and the three register memories (222, 223, and 224) are used to store other microblock MVs required for reference in the prediction of a macroblock 31 that is currently to be predicted, so as to perform the MV prediction to the macroblock 31 that is currently to be predicted. The memory allocation means belongs to a conventional art, which can be realized with reference to the prior art.

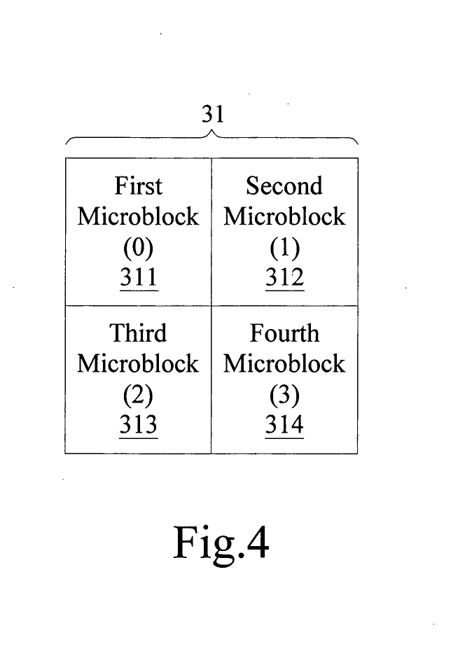

It has been mentioned above that, the MV prediction method of the present invention is based on 4 MV-MB video images, so each macroblock 31 that is currently to be predicted is represented by four microblock MVs. Therefore, each macroblock in the video image must be segmented into microblocks by a video image segmentation means. As shown in FIG. 4, each macroblock 31 that is currently to be predicted is segmented into four microblocks with the same size, and according to their current positions in the macroblock 31, in the present invention, the top left microblock is defined as the first microblock 311 (shown as 0 in a part of the figure), the top right microblock is defined as the second microblock 312 (shown as 1 in a part of the figure), the bottom left microblock is defined as the third microblock 313 (shown as 2 in a part of the figure), and the bottom right microblock is defined as the fourth microblock 314 (shown as 3 in a part of the figures). The video image segmentation means can also be realized through a conventional technology, which thus is not described herein.

It should be noted that, in a general conventional video image, the macroblock 30 normally has a size of 16×16 pixels, so the size of each segmented microblock is normally 8×8 pixels. Accordingly, it is derived in the present invention that, the required size of the row memory 221 is only “length of the video image/8×2 (two components)×(data volume of an MV component)”, and the required size of each register memory is “2 (two components)×(data volume of an MV component)”. Each MV has two MV components, and the data volume of each MV component varies depending upon actual conditions.

The key point of the technical features of the entire MV prediction method and MV prediction apparatus of the present invention lies in the MV prediction means, including two parts, one is the technical content of the MV prediction for each of the microblocks after segmenting the macroblock 31, and the other is the technical content of the storage updating management technology for the allocated row memory 221 and three register memories (222, 223, and 224) during the MV prediction.

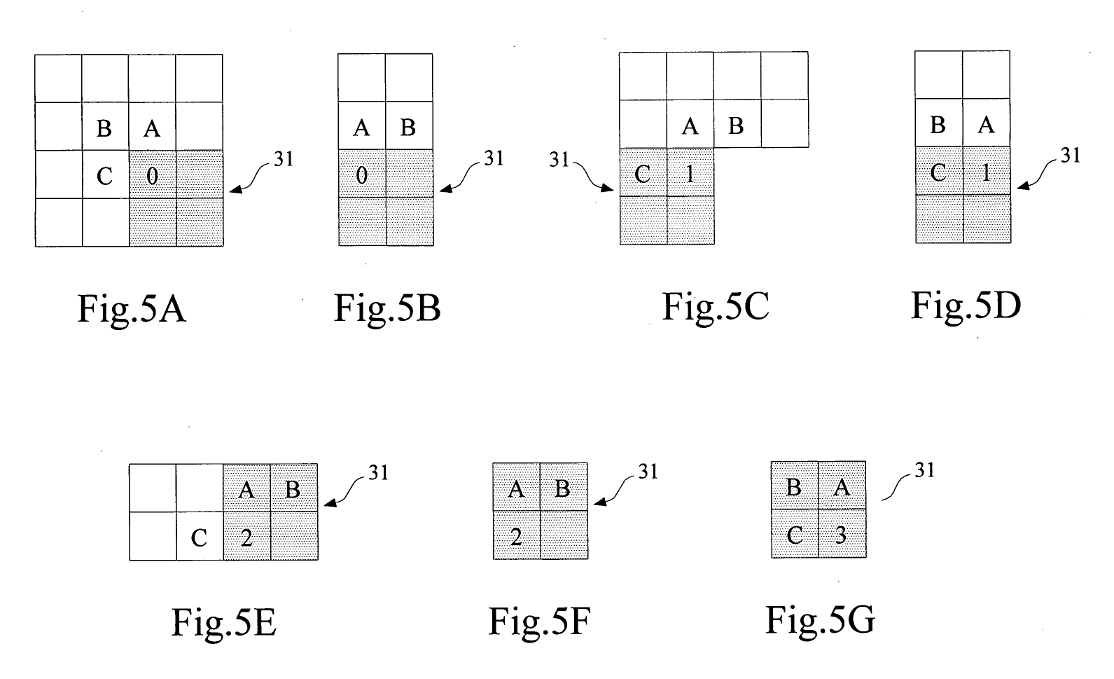

Details about the MV prediction of each of the microblocks in the macroblock 31 that is currently to be predicted will be illustrated with reference to FIGS. 5A to 5G. Basically, in the present invention, the MV prediction for each of the microblocks of the macroblock 31 that is currently to be predicted is performed in an order of the first microblock 311, the second microblock 312, the third microblock 313, and the fourth microblock 314, which will be further illustrated as follows.

(1) Firstly, before the actual MV prediction is performed to the macroblock 31 that is currently to be predicted, the MV prediction means reads the MV of each of the microblocks that has been predicted and stored in the row memory 221 in the neighboring microblock row 45 above the macroblock row 40 that is currently to be predicted (as shown in FIG. 3). As the video image processing of various microblocks follows an order of from left to right and from top to bottom in the conventional art, if the MV prediction to all macroblock rows 40 above the macroblock row 40 that is currently to be predicted has already been completed, however, in the present invention, the subsequent MV prediction only uses the microblock row 45 in the lower half of the neighboring macroblock row 40 above the macroblock row 40 that is currently to be predicted, so only this part is registered in the row memory 221 for subsequent application.

(2) The MV prediction of the first microblock 311 can be classified into two situations. The first situation is that the macroblock 31 that is currently to be predicted is not located at the leftmost of the macroblock row 40, and the macroblock row 40 is not the uppermost macroblock 40 in the entire video image. At this time, according to the corresponding position condition predetermined in the MV prediction means, the first register memory 222 stores a microblock MV in the row memory 221 that has the same position order as the first microblock 311, the second register memory 223 stores a microblock MV in the row memory 221 at a top left position relative to the first microblock 311, and the third register memory 224 stores the microblock MV in the row memory 221 at a left position neighboring the first microblock 311. Then, the MVs in the three register memories (222, 223, and 224) are used to perform the MV prediction to the first microblock 311 (as shown in FIG. 5A). The second situation is that the macroblock 31 that is currently to be predicted is located at the leftmost of the macroblock row 40, and the macroblock row 40 is not the topmost macroblock row 40 in the video image. At this time, according to the corresponding position condition, the first register memory 222 also stores the microblock Mv in the row memory 221 that has the same position order as the first microblock 311, which is the same as the first situation, the second register memory 223 stores the microblock MV in the row memory 221 at a top right position relative to the first microblock 311, and as no reference microblock MV exists to the left of the third register memory 224, the third register memory 224 remains at the no storage state, so as to perform the MV prediction to the first microblock 311 (as shown in FIG. 5B).

It should be noted that, if the MV prediction is performed in a 1 MV video image, the mode similar to the MV prediction to the first microblock 311 can be used to complete the MV prediction to each of the macroblocks 31 that are currently to be predicted.

(3) After the first microblock 311 has been predicted, the MV prediction to the second microblock 312 will be performed, which can also be classified into two situations. The first situation is that the macroblock 31 that is currently to be predicted is not located at the rightmost of the macroblock row 40, and the macroblock row 40 is not the topmost macroblock row 40. At this time, according to the corresponding position condition, the first register memory 222 stores a microblock MV in the row memory 221 that has the same position order as the second microblock 312, the second register memory 223 stores a microblock MV in the row memory 221 at a top right position relative to the second microblock 312, and the third register memory 224 stores an MV of the first microblock 311 that has just been predicted, so as to perform the MV prediction to the second microblock 312 (as shown in FIG. 5C). The second situation is that the macroblock 31 that is currently to be predicted is located at the rightmost of the macroblock row 40, and the macroblock row 40 is not the topmost macroblock row 40. At this time, according to the predetermined corresponding position condition, the first register memory 222 stores the microblock Mv in the row memory 221 that has the same position order as the second microblock 312, the second register memory 223 stores the microblock MV in the row memory 221 at a top left position relative to the second microblock 312, and the third register memory 224 also stores the MV of the first microblock 311 that has already been predicted, which is the same as the first situation, so as to perform the prediction to the second microblock 312 (as shown in FIG. 5D).

(4) When the third microblock 313 is to be processed, similarly, two situations have to be considered. The first situation is that the macroblock 31 that is currently to be predicted is not located at the leftmost of the macroblock row 40, and regardless of whether the macroblock row 40 is the topmost macroblock row 40 in the entire video image or not. At this time, according to the corresponding position condition, the first register memory 222 stores the MV of the first microblock 311 that has already been predicted, the second register memory 223 stores the MV of the second microblock 312 that has already been predicted, and the third register memory 224 stores a microblock. MV in a macroblock at a left position neighboring the third microblock 313, so as to perform the prediction (as shown in FIG. 5E). The second situation is that the macroblock 31 that is currently to be predicted is located at the leftmost of the macroblock row 40, and regardless of whether the macroblock row 40 is the topmost macroblock row 40 or not. At this time, according to the corresponding position condition, the first register memory 222 and the second register memory 223 have the same circumstance as in the first situation, but the third register memory 224 remains at the no storage state, as no reference microblock MV exists to the left. Then, the prediction is performed according to the MVs stored in the first register memory 222 and the second register memory 223 (as shown in FIG. 5F).

(5) Finally, the MV of the fourth microblock 314 will be predicted. At this time, as the MV prediction for the other three microblocks (311, 312, and 313) in the macroblock 31 that is currently to be predicted has already been completed, the first register memory 222 stores the MV of the first microblock 311, the second register memory 223 stores the MV of the second microblock 312, and the third register memory 224 stores the MV of the third microblock 313, so as to perform the MV prediction to the fourth microblock 314 (as shown in FIG. 5G).

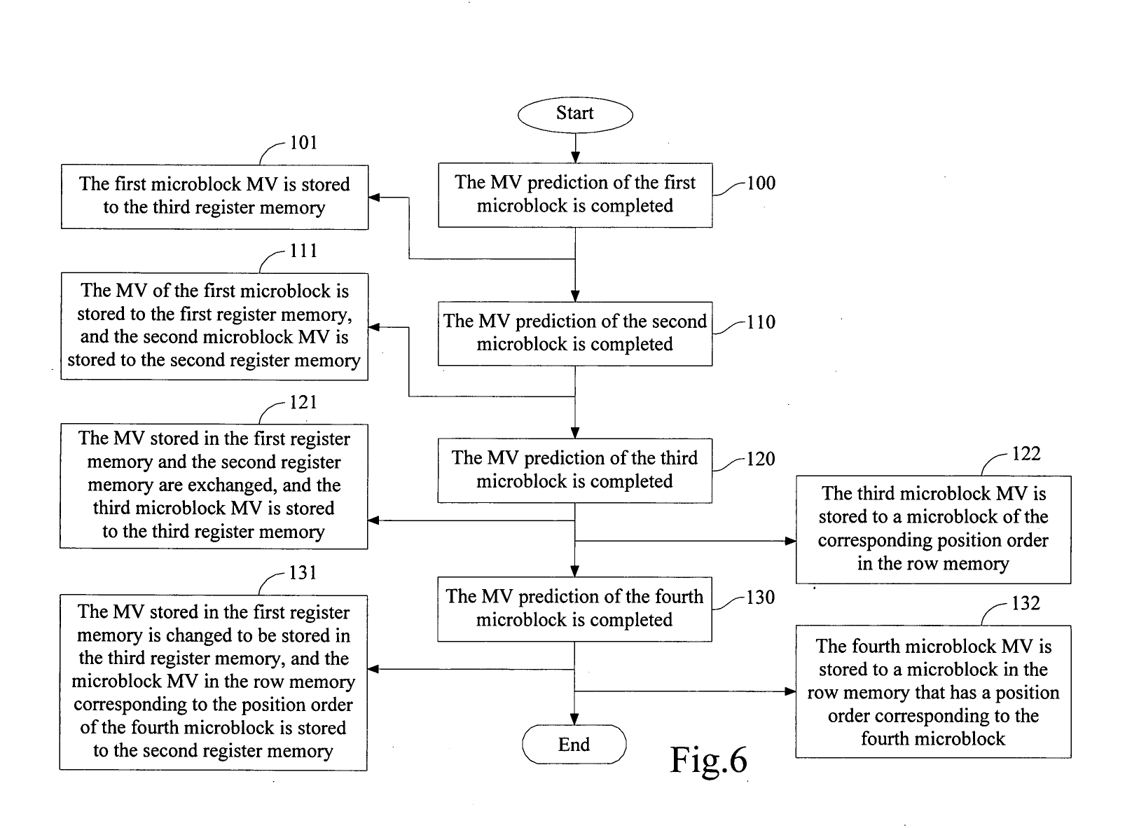

In general, the order for the MV prediction of various microblocks (311 to 314) in each macroblock 31 that is currently to be predicted, the process for the register memories (222 to 224) to utilize the MVs of the microblock row 45 stored in the row memory 221, and the process for storing other reference MVs of the prediction have been illustrated above. However, in actual operation, as the MVs required as a reference when processing each of the microblocks (311 to 314) are different, in order to utilize the allocated memory space more effectively, the present invention further provides a detailed technical solution to the storage updating management required in the MV prediction, as shown in FIG. 6.

As shown in FIG. 6, as for a macroblock 31 that is currently to be predicted, after Step 100 to Step 130, the MV prediction for the microblocks (311 to 314) in the macroblock 31 that is currently to be predicted will be completed. After the MV prediction for the microblocks (311 to 314) has been completed, the MV prediction means of the MV prediction method according to the present invention will use a predetermined storage updating condition to perform the MV updating management to MVs stored in the row memory 221 and the three register memories (222 to 224), so as to prevent the problem that the MV is covered or the MV that is required as a reference does not exist when performing the MV prediction to the next microblock, and meanwhile, to enhance the overall application efficiency to the allocated memory, without allocating redundant and unnecessary memory spaces.

Several time points when the storage updating condition is required as a reference and the detailed operations are further illustrated as follows.

(1) After finishing Step 100 and before entering Step 110, according to the storage updating condition, the MV in the first microblock 311 that has already been predicted is stored in the third register memory 224 (Step 101).

(2) After finishing Step 110 and before entering Step 120, according to the storage updating condition, the MV in the first microblock 311 is stored in the first register memory 222, and meanwhile, the MV of the second microblock 312 is stored in the second register memory 223 (Step 111).

(3) After finishing Step 120 and before entering Step 130, according to the storage updating condition, Step 121 and Step 122 will be performed. In Step 121, the MV of the first microblock 311 stored in the first register memory 222 and the MV of the second microblock 312 stored in the second register memory 223 are exchanged, such that the first register memory 222 stores the MV of the second microblock 312, and the second register memory 223 stores the MV of the first microblock 311, and meanwhile, the MV of the third microblock 313 is stored in the third register memory 224. Then, Step 122 is performed, in which the MVs stored in the row memory 221 are updated. At this time, the MV of the third microblock 313 is stored in a microblock in the row memory 221 that has the same position order as the third microblock 313.

(4) After Step 130, the MV prediction of all microblocks (311 to 314) in the macroblock 31 that is currently to be predicted has been completed. Before it is ready to change to a next macroblock 31 that is currently to be predicted, Step 131 and Step 132 are performed. In Step 131, the MV of the second microblock 312 stored in the first register memory 222 is stored in the third register memory 224, and meanwhile, the microblock MV in the row memory 221 that has the same position order as the fourth microblock 314 is stored in the second register memory 223. Then, in Step 132, the MV of the fourth microblock 314 is stored in a microblock in the row memory 221 that has the same position order as the fourth microblock 314.

During the entire course, as the row memory 221 is updated as the prediction of the third microblock 313 and the fourth microblock 314 is completed, when the MV prediction for all macroblocks 31 that are currently to be predicted in the macroblock row 40 that is to be predicted is completed, all of the MVs in the microblock row 45 stored in the row memory 221 have been updated, so as to be used for predicting the MVs of the next macroblock row 40 that is currently to be predicted.

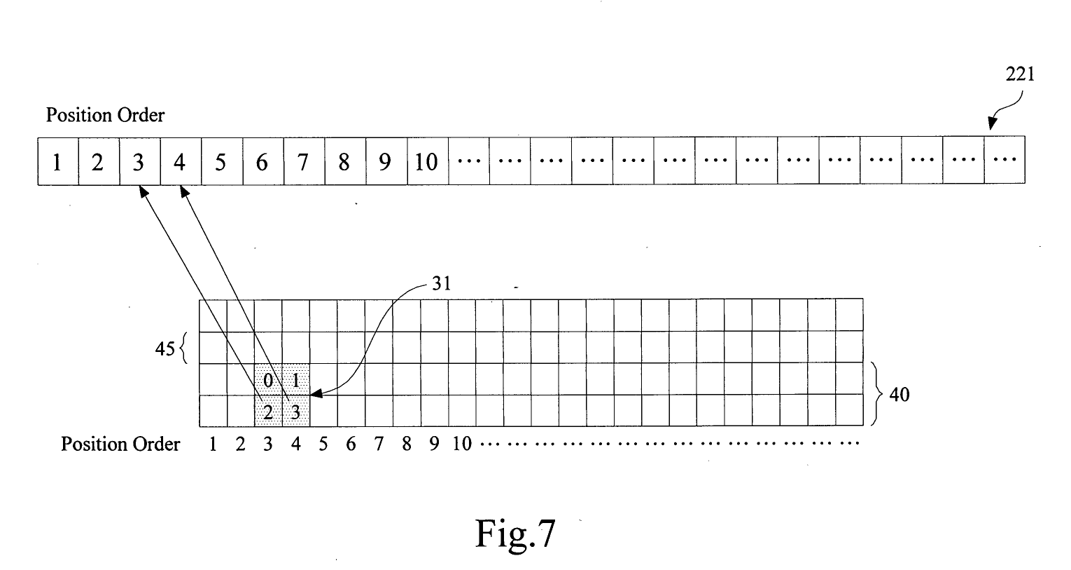

It has been mentioned above for several times that, the MVs of the microblocks in the macroblock 31 that is currently to be predicted are updated to be stored in microblocks having the same position orders in the row memory 221. The detail implementation can be obtained referring to FIG. 7. Basically, the length of the row memory 221 is the same as the number of microblocks in the horizontal direction of the video image, and in the row memory 21, the position order can be numbered according to the number of the segmented microblocks in a row of the video image, such as 1, 2, and 3 . . . . For example, if the length of the video image is 640 pixels, after being segmented according to the video image segmentation means described above, one row is segmented into 80 microblocks (640/8). Therefore, the number of the position order is 1 to 80, and the position order is corresponding to each of the microblocks in the microblock row 45. As shown in FIG. 7, the third microblock 313 and the fourth microblock 314 in the macroblock 31 that is currently to be predicted are respectively at the third and fourth position orders in the macroblock row 40. Therefore, when the storage of the row memory 221 is updated, the third microblock 313 and the fourth microblock 314 are updated to the microblocks at the third and fourth position orders in the row memory 221 respectively.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A motion vector prediction method, applicable for a video image encoder/decoder to perform a motion vector (Mv) prediction of a video image with a length of M pixels and a width of N pixels, the method comprising following steps:
allocating a row memory, a first register memory, a second register memory, and a third register memory in the video image encoder/decoder;
segmenting each macroblock in the video image, such that each macroblock includes a first microblock, a second microblock, a third microblock, and a fourth microblock that are of a same size;
reading each microblock MV that has been predicted in a neighboring microblock row above a row of the macroblock that is currently to be predicted, and storing the microblock MVs in the row memory; and
sequentially performing the MV prediction to the first microblock, the second microblock, the third microblock, and the fourth microblock in the macroblock that is currently to be predicted;
wherein the first register memory, the second register memory, and the third register memory respectively store the microblock MVs meeting a predetermined position condition corresponding to the microblock that is currently to be predicted, so as to perform the MV prediction to the first microblock, the second microblock, the third microblock, and the fourth microblock;
wherein when the microblock that is currently to be predicted or the macroblock that is currently to be predicted changes, the row memory, the first register memory, the second register memory, or the third register memory are updated according to a predetermined storage updating condition.

2. The motion vector prediction method as claimed in claim 1, wherein a size of the macroblock is 16×16 pixels, and a size of the microblock is 8×8 pixels.

3. The motion vector prediction method as claimed in claim 1, wherein a size of the row memory is M/8×2 (two components)×(data volume of an MV component), and sizes of the first register memory, the second register memory, and the third register memory are 2 (two components) x (data volume of an MV component).

4. The motion vector prediction method as claimed in claim 1, wherein the microblock MVs stored in the first register memory, the second register memory, and the third register memory are from the macroblock row that is currently to be predicted or from the row memory.

5. The motion vector prediction method as claimed in claim 1, wherein the first microblock, the second microblock, the third microblock, and the fourth microblock are sequentially located at a top left position, a top right position, a bottom left position, and a bottom right position of the macroblock.

6. The motion vector prediction method as claimed in claim 5, wherein when the MV prediction is performed to the first microblock, if the macroblock that is currently to be predicted is not located at a leftmost of the macroblock row, and the macroblock row is not a topmost macroblock row, according to a corresponding position condition, the first register memory stores the microblock MV in the row memory that has a same position order as the first microblock, the second register memory stores the microblock MV in the row memory at a top left position relative to the first microblock, and the third register memory stores the microblock MV that is at a left position neighboring the first microblock, so as to perform the MV prediction.

7. The motion vector prediction method as claimed in claim 6, wherein when the MV prediction is performed to the first microblock, if the macroblock that is currently to be predicted is located at the leftmost of the macroblock row, and the macroblock row is not the topmost macroblock row, according to the corresponding position condition, the first register memory stores the microblock MV in the row memory that has the same position order as the first microblock, the second register memory stores the microblock MV in the row memory at a top right position relative to the first microblock, and the third register memory remains at a no storage state, so as to perform the MV prediction.

8. The motion vector prediction method as claimed in claim 5, wherein when the MV prediction is performed to the second microblock, if the macroblock that is currently to be predicted is not located at a rightmost of the macroblock row, and the macroblock row is not a topmost macroblock row, according to a corresponding position condition, the first register memory stores the microblock MV in the row memory that has a same position order as the second microblock, the second register memory stores the microblock MV in the row memory at a top right position relative to the second microblock, and the third register memory stores the microblock MV in the first microblock, so as to perform the MV prediction.

9. The motion vector prediction method as claimed in claim 8, wherein when the MV prediction is performed to the second microblock, if the macroblock that is currently to be predicted is located at the rightmost of the macroblock row, and the macroblock row is not the topmost macroblock row, according to the corresponding position condition, the first register memory stores the microblock MV in the row memory that has the same position order as the second microblock, the second register memory stores the microblock MV in the row memory at a top left position relative to the second microblock, and the third register memory stores the microblock MV in the first microblock, so as to perform the MV prediction.

10. The motion vector prediction method as claimed in claim 5, wherein when the MV prediction is performed to the third microblock, if the macroblock that is currently to be predicted is not located at a leftmost of the macroblock row, according to a corresponding position condition, the first register memory stores the microblock MV in the first microblock, the second register memory stores the microblock MV in the second microblock, and the third register memory stores the microblock MV at a left position neighboring the third microblock, so as to perform the MV prediction.

11. The motion vector prediction method as claimed in claim 10, wherein when the MV prediction is performed to the third microblock, if the macroblock that is currently to be predicted is located at the leftmost of the macroblock row, according to the corresponding position condition, the first register memory stores the microblock MV in the first microblock, the second register memory stores the microblock MV in the second microblock, and the third register memory remains at a no storage state, so as to perform the MV prediction.

12. The motion vector prediction method as claimed in claim 5, wherein when the MV prediction is performed to the fourth microblock, according to a corresponding position condition, the first register memory stores the microblock MV in the second microblock, the second register memory stores the microblock MV in the first microblock, and the third register memory stores the microblock MV in the third microblock, so as to perform the MV prediction.

13. The motion vector prediction method as claimed in claim 9, further comprising storing the microblock MV in the first microblock to the third register memory according to the storage updating condition, after the MV prediction of the first microblock is completed and before changing to the MV prediction of the second microblock.

14. The motion vector prediction method as claimed in claim 11, further comprising storing the microblock MV in the first microblock to the first register memory, and meanwhile, storing the microblock MV in the second block to the second register memory according to the storage updating condition, after the MV prediction of the second microblock is completed and before changing to the MV prediction of the third microblock.

15. The motion vector prediction method as claimed in claim 12, further comprising exchanging the MVs stored in the first register memory and the second register memory, and meanwhile, storing the microblock MV in the third microblock to the third register memory according to the storage updating condition, after the MV prediction of the third microblock is completed and before changing to the MV prediction of the fourth microblock.

16. The motion vector prediction method as claimed in claim 15, further comprising storing the microblock MV in the third microblock to a microblock in the row memory that has a same position order as the third microblock.

17. The motion vector prediction method as claimed in 12, further comprising storing the MV stored in the first register memory to the third register memory, and meanwhile, storing a microblock MV in the row memory that has a same position order as the fourth microblock to the second register memory, after the MV prediction of the fourth microblock is completed and before the macroblock that is currently to be predicted changes.

18. The motion vector prediction method as claimed in claim 17, further comprising storing the microblock MV in the fourth microblock to a microblock in the row memory that has the same position order as the fourth microblock.

19. A motion vector prediction apparatus, applicable for a video image encoder/decoder, to perform motion vector (MV) prediction to a video image with a length of M pixels and a width of N pixels, the apparatus comprising:
a memory allocating means, for allocating a row memory, a first register memory, a second register memory, and a third register memory in the video image encoder/decoder;
a video image segmentation means, for segmenting each macroblock in the video image, such that each of the macroblocks includes a first microblock, a second microblock, a third microblock, and a fourth microblock that are of a same size; and
an MV prediction means, for reading MV of each predicted microblock in a neighboring microblock row above a macroblock row that is currently to be predicted, storing the MVs to the row memory, and sequentially predicting the MVs of the first microblock, the second microblock, the third microblock, and the fourth microblock for the macroblock that is currently to be predicted;
wherein the MV prediction means uses the first register memory, the second register memory, and the third register memory to store microblock MVs meeting a predetermined position condition corresponding to the microblock that is currently to be predicted respectively, so as to perform the MV prediction to the first microblock, the second microblock, the third microblock, and the fourth microblock;
wherein when the microblock that is currently to be predicted or the macroblock that is currently to be predicted changes, the MV prediction means updates the row memory, the first register memory, the second register memory, or the third register memory according to a predetermined storage updating condition.

20. The motion vector prediction apparatus as claimed in claim 19, wherein a size of the macroblock is 16×16 pixels, and a size of the microblock is 8×8 pixels.

21. The motion vector prediction apparatus as claimed in claim 19, wherein a size of the row memory is M/8×2 (two components)×(data volume of an MV component), and sizes of the first register memory, the second register memory, and the third register memory are 2 (two components)×(data volume of an MV component).

22. The motion vector prediction apparatus as claimed in claim 19, wherein the microblock MVs stored in the first register memory, the second register memory, and the third register memory are from a row of the macroblock that is currently to be predicted or from the row memory.

23. The motion vector prediction apparatus as claimed in claim 19, wherein the first microblock, the second microblock, the third microblock, and the fourth microblock are sequentially located at a top left position, a top right position, a bottom left position, and a bottom right position of the macroblock.
